(19) United States
(12) Patent Application Publication
(10) Pub. No.: US 2008/0118174 A1
(43) Pub. Date: May 22, 2008

(54) Method and Apparatus for Detecting Field Order in Interlaced Material

(75) Inventor: David M. Baylon, San Diego, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/562,517

(22) Filed: Nov. 22, 2006

(51) Int. Cl. G06K 9/40

(52) U.S. Cl. 382/263

(57) ABSTRACT

Method and apparatus for determining a temporal sequence of an interlaced image sequence is described. In one embodiment, a first field pair and a second field pair are constructed from portions of both a first original field pair and a second original field pair from the interlaced image sequence. The first field pair and the second field pair are subsequently filtered to produce a respective first output and second output. Afterwards, the first output and the second output are processed to determine the temporal sequence of the interlaced image sequence.

### BACKGROUND OF THE INVENTION

1. Field of the Invention

Embodiments of the present invention generally relate to the processing of interlaced video data. More specifically, the present invention relates to a method and apparatus for detecting the proper field order within interlaced video.

1. Description of the Related Art

In traditional analog interlaced video the timing of the two fields is determined within the analog video signal. However, in today's converging world of analog and digital video, it becomes increasingly possible that information about field order is lost or not known. The analog interlaced video may undergo digital sampling, editing, or processing which alters or removes the field order information. This invention relates to a simple and efficient approach for detecting the correct field order from only the interlaced video data. The method is based on proposed measurements of “zipper” points and energy of the interlaced video. The present invention does not rely on pre-determined thresholds such as described in the related art, and presents several methods for detecting the field order in interlaced material.

For display, compression, or processing of interlaced material, it is important to maintain correct field timing. If the top and bottom (or even and odd) fields are displayed in reverse chronological order, visual artifacts can occur especially for high motion scenes. Video compression and processing with incorrect field order can result in a loss of compression efficiency and video quality.

In many video applications, the proper scan or display field order can be obtained from temporal side information transmitted or stored with the video. However, when this video is digitally captured or edited, the field order information may be lost or incorrect. This invention relates to a simple motion-based approach for detecting the field order using only the interlaced video data, where each successive pair of top and bottom fields of the interlaced video has been interleaved into a single frame. Although interlaced motion detection has been widely studied, such as in de-interlacing, its application to field order detection does not appear to have received attention.

Thus, there is a need in the art for a method and apparatus for detecting the proper field order in interlaced video.

### SUMMARY OF THE INVENTION

In one embodiment, a method and apparatus for determining a temporal sequence of an interlaced image sequence is described. Specifically, a first field pair and a second field pair are constructed from portions of both a first original field pair and a second original field pair from the interlaced image sequence. The first field pair and the second field pair are subsequently filtered to produce a respective first output and second output. Afterwards, the first output and the second output are processed to determine the temporal sequence of the interlaced image sequence.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a system for detecting the proper field order in interlaced video in accordance with the present invention;

FIG. 2 depicts an exemplary depiction of a 6-point zipper filter in accordance with the present invention;

FIG. 3 depicts a flow diagram corresponding to a method for detecting the proper field order in interlaced video in accordance with the present invention;

FIG. 4 depicts a processing order for zipper measurements over a sequence;

FIG. 5 is a block diagram depicting an exemplary embodiment of a computer suitable for implementing the processes and methods described herein;

FIG. 6 is a block diagram depicting an illustrative method for field order detection based on zipper energy;

FIG. 7 is a block diagram depicting an illustrative method for field order detection based on field DC; and

FIG. 8 is a block diagram depicting an illustrative method for field order detection based on field differences.

To facilitate understanding, identical reference numerals have been used, wherever possible, to designate identical elements that are common to the figures.

### DETAILED DESCRIPTION

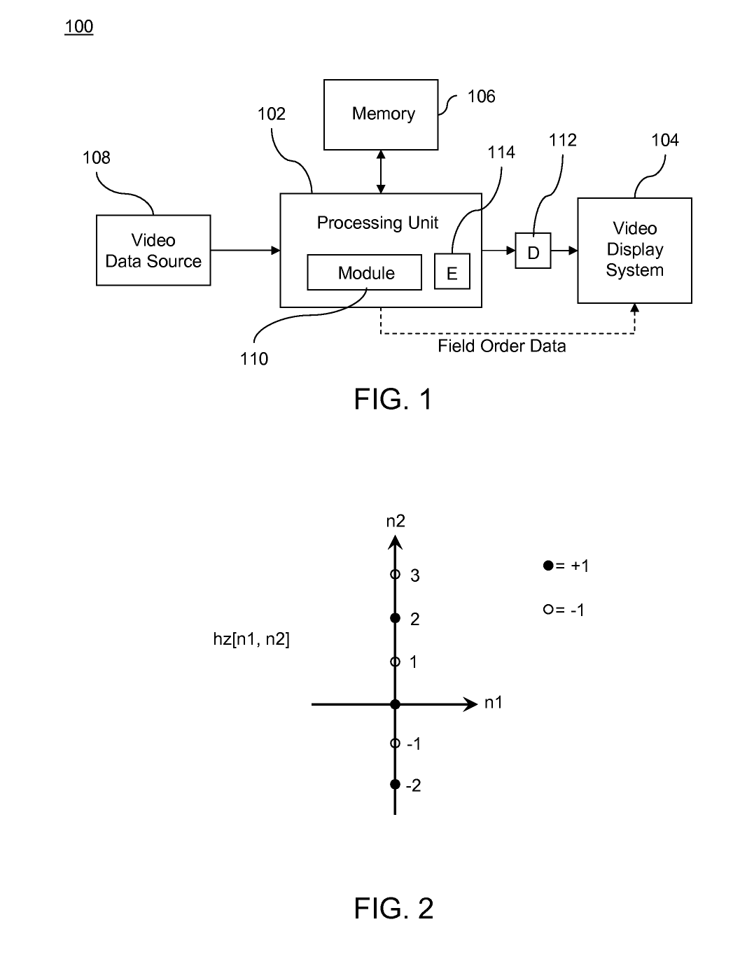

FIG. 1 depicts a system 100 for detecting the field order of interlaced video frames. The system 100 typically comprises a processing unit 102, a video display system 104, memory 106, a decoder 112, and a video data source 108. Depending on the embodiment, the processing unit 102 may comprise a personal computer (PC), a portable laptop computer, a server computer, or like device. The processing unit 102 may contain a field order detection module 110, which may be a software module running on a CPU and utilizing memory 106 to store intermediate data. Similarly, the detection module 110 may be implemented as a hardware processing module as well. Although the detection module 110 is disclosed as being deployed in the processing unit 102, it is not so limited. Namely, the functions performed by the field order detection module can be deployed within a larger system, e.g., an encoder, a decoder, and the like. The processing unit 102 may also include an encoder 114, which may be configured to convert original video data into a video bit stream. Although depicted within the processing unit 102, the encoder 114 may instead reside outside of the processing unit 102 in alternative embodiment. Similarly, in another embodiment, the encoder 114 may be configured to directly receive the field order data for improved video compression (i.e., knowledge of field order for temporal prediction processing may improve data compression). The video bit stream from the encoding unit 114 is ultimately received by a decoder 112 prior to being displayed on the video display system 104. The video data source 108 may comprise any one of a number of various data sources. Notably, the source 108 may include a storage device (e.g., a disk drive), a video decoder, a video processor, a video editor, and the like.

In one illustrative embodiment, after performing field order detection methods on the video data received from the source 108, the processing unit 102 sends the processed video data and the detected field order information to a video display system 104. The video display system 104 may comprise any device that provides a visual image, such as, a computer screen display, a television, a monitor, and the like. The field order information is shown in FIG. 1 using a dashed line since the field order information may already be incorporated in the video data signal. Those skilled in the art realize that the system 100 may be configured in a number of ways in order to perform a field order detection process without deviating from the present invention.

The motivation behind determining correct field order lies in the analysis of motion or motion flow in the video sequence. Since video sequences typically exhibit a smooth motion flow across several frames, this can be exploited in detecting correct field order. To illustrate this, let “Ft” denote the top field and “Fb” denote the bottom field of frame number “F”. Let the fields of the first eight frames of a top field first sequence and a bottom field first sequence be:
top first=(0t, 0b, 1t, 1b, 2t, 2b, 3t, 3b, 4t, 4b, 5t, 5b, 6t, 6b, 7t, 7b, . . . ) and
bottom first=(0b, 0t, 1b, 1t, 2b, 2t, 3b, 3t, 4b, 4t, 5b, 5t, 6b, 6t, 7b, 7t, . . . ).

If one unit (+1) is designated as the time from two adjacent fields in correct order, then the time differences between consecutive fields displayed in the correct order are:
correct order=(+1, +1, +1, +1, +1, +1, +1, . . . ).

On the other hand, the time differences between fields displayed in the wrong order are:
incorrect order=(−1, +3, −1, +3, −1, +3, −1, . . . )

So for a sequence that contains objects having a smooth motion flow, if the fields are displayed properly, then the “correct order” motion flow should be detected. However if the fields are not displayed properly, then the “incorrect order” motion flow should be detected. Assuming that typical video content generally exhibits a smooth motion flow across fields instead of a jerky forward-backward regular motion across fields, one presented approach for detecting field order is to initially assume that the top field is first, and if the “incorrect order” motion flow is detected, then the sequence should be determined to be a bottom field first sequence instead.

Determining motion flow over a group of frames can be done in a variety of ways, many of which require significant computation. Furthermore, determining whether the motion direction follows an overall smooth pattern versus a forward-backward pattern as indicated above is often not straightforward due to the presence of local motions and possible inaccuracies in the motion measurements.

In order to get around these issues, consider two consecutive frames-curr(0) and next(1)—and their respective fields: curr_top(0t), curr_bot(0b), next_top(1t), next_bot(1b). Recall that the temporal order of these fields under the assumption of top or bottom field first will be:
topfirst=(0t, 0b, 1t, 1b) and
bottom first=(0b, 0t, 1b, 1t).

Let “motion(i,j)” indicate the relative amount of motion magnitude between i and j. Assuming typical object motion, then for top field first sequences, it might be expected that because of the smaller temporal interval, that there is less object displacement between (1t,0b) than between (0t,1b). On the other hand, for bottom field first sequences, it might be expected that there is less object displacement between (0t,1b) than between (1t,0b). That is,
top first: motion(1t,0b)<motion(0t,1b)
bottom first: motion(1t,0b)≧motion(0t,1b).

Therefore, one approach to detect the correct field order is to compare motion(1t,0b) with motion(0t,1b) and to use the above “rule”. Note that compared to the approach outlined earlier using both motion flow direction and magnitude (e.g. (−1, +3, −1, +3, −1, +3, −1, . . . ) for incorrect field order), here only the relative motion magnitude is used.

There are many ways to measure “motion”, such as by summing the motion vector magnitude(s) between the fields, but these can still require significant computation. In one embodiment, the interfield motion is measured by observing that moving objects exhibit the well-known “zigzag” or “zipper” effects near object boundaries in a frame. This is especially true for interlaced material where fields are pair-wise interleaved within the frame. Since the motion measurements motion(1t,0b) and motion(0t,1b) are interfield motions between fields in a current and next frame, if these fields are assembled into a (hypothetical) new frame, interlaced zipper effects are expected to appear around edges of moving objects. Furthermore, these effects should be more pronounced the larger the interfield motion.

FIG. 2 shows a linear shift invariant vertical “zipper filter” for measuring interfield motion by detecting zipper effects in an interlaced frame. With a filter length N=6, it attempts to distinguish localized interfield motion. By applying this filter near edges of moving objects in a frame, the filtered output magnitude is expected to be large relative to objects with less motion. Alternatively, the present invention presents the application of the filter over the entire image, as this avoids having to explicitly detect the edges of moving objects (although the filter already implicitly acts as an edge detector). The interfield motion can be measured by counting the number of filtered output magnitudes (or magnitudes squared) greater than some threshold T, known as “zipper points”. So if the frame (0t,1b) has more zipper effects than (1t, 0b), then the sequence is determined to be top field first; otherwise, it is bottom field first.

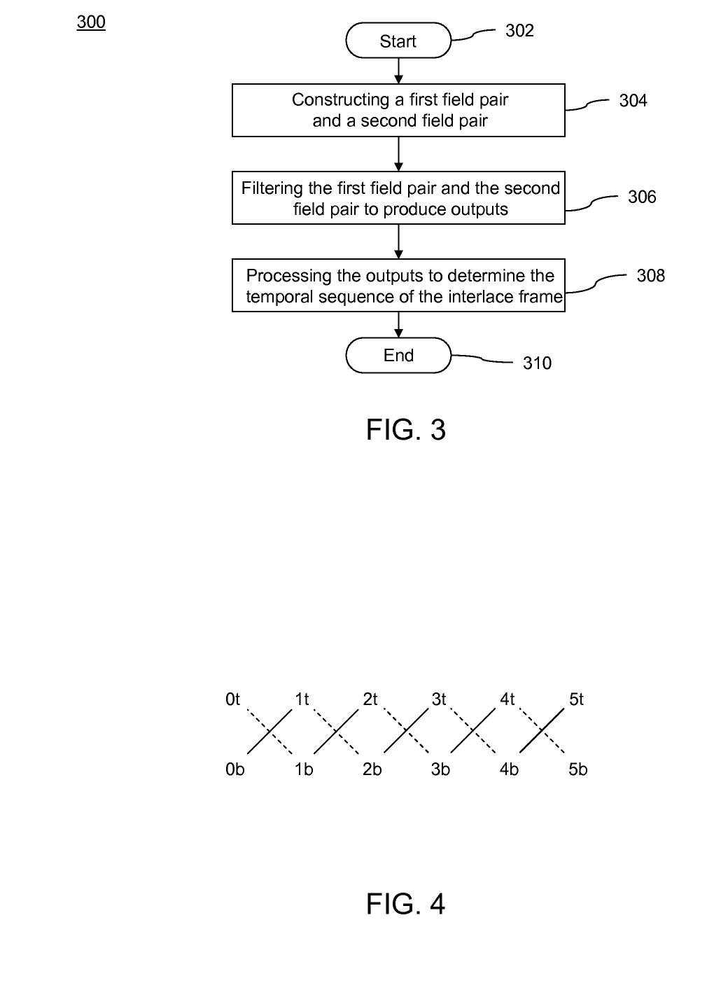

A step-by-step process depicting this approach (i.e., one embodiment of the present invention) is illustrated in FIG. 3. Namely, FIG. 3 is a flow diagram depicting an exemplary embodiment of a method 300 for detecting the correct field order in interlaced video in accordance with one or more aspects of the invention. The method 300 begins at step 302 and proceeds to step 304 where a first field pair and a second field pair are constructed or received. In one embodiment, the first field pair and the second field pair are assembled from portions of both a first original field pair and a second original field pair from an interlaced frame. For example, let the current frame 0 fields be (0t,0b) and the fields of the next frame 1 be (1t,1b). Assemble two new frames x₀[n₁,n₂]=(1t, 0b) and x₁[n₁,n₂]=(0t,1b), corresponding to the current frame 0 and next frame 1, respectively. Let x₀ and x₁ be N_{c} columns by Nᵣ rows. For example, if the frames x₀ and x₁ are 720 columns by 480 rows, then N_{c}=720 and Nᵣ=480.

At step 306, the first field pair and the second field pair are both filtered. In one embodiment, the first field pair (x₀) and the second field pair (x₁) is applied to a vertical high pass filter (e.g., a six point zipper filter). The filter (or separate identical filters, depending on the embodiment) applied to x₀ and x₁ produces the outputs y₀ and y₁, respectively. Edge effects of the filtering can be ignored, so it is assumed that y₀ and y₁ are also of size N_{c} columns by Nᵣ rows. In one embodiment, these outputs may also be applied to a zipper count function to produce C_{T}(y₀) and C_{T}(y₁), which represent scalars signifying the number of points in y₀ and y₁ whose output magnitudes (or magnitudes squared) are greater than a specified threshold T, respectively.

At step 308, the outputs are processed to determine the temporal sequence of the interlaced frame. In one embodiment, the outputs derived from step 306 are compared or applied to a ratio test to ascertain whether the interlaced frame is either “top first” or “bottom first.” For example, the output may be applied to the formula:

$${R}_{N}^{T} ≡ ( \frac{{C}_{T} ( {y}_{1} [ {n}_{1} , {n}_{2} ] )}{{C}_{T} ( {y}_{0} [ {n}_{1} , {n}_{2} ] )} ) \begin{matrix}top first \\ > \\ < \\ bottom first\end{matrix} 1$$

where N represents the length of the filter used to generate the outputs y₀ and y₁. Notably, if the numerator C_{T}(y₁) is greater than the denominator C_{T}(y₀), the equation indicates that the temporal sequence of the interlaced frame is “top first.” Conversely, if the opposite is true, then the temporal sequence of the interlaced frame is “bottom first.” This formula is explained in greater detail below (see equation (3)). The method 300 ends at step 310.

In other words, if the (0t,1b) frame is more “strongly interlaced” than the (1t, 0b) frame, then the top field is detected to be first. Note that it is possible for x₀[n₁,n₂] and x₁[n₁,n₂] to correspond to the previous and current frames, respectively. It is also possible to eliminate the threshold T by simply comparing the sum of absolute values (or squared values) of the filtered output pixels of x₀[n₁,n₂] and x₁[n₁,n₂]. Although FIG. 2 illustrates the N=6 point zipper filter, a more general N-point (N even positive) zipper filter h_{Z}[n₁,n₂] can be defined as follows:

$${h}_{z} [ {n}_{1} , {n}_{2} ] = \{ \begin{matrix}{( - 1 )}^{{n}_{2}} , & {n}_{1} = 0 and - ( N / 2 - 1 ) \leq {n}_{2} \leq ( N / 2 ) \\ 0 & otherwise\end{matrix} \qquad ( 1 )$$

This method can be applied to consecutive pairs of frames over an entire sequence, and the detection results can be used to determine the overall sequence field order. On the other hand, for sequences with bad field edits which inadvertently change the field order, the method can be applied to signal the location of the bad field edit. The zipper filtering operation is not computationally intensive, requiring only simple additions and subtractions. In addition to being useful for detecting field order of interlaced material, other applications include detection on mixed interlace/progressive content such as 3:2 field pulldown material.

The present invention also presents an analysis of a method which provides further insight into the detection algorithm. Let the zipper filtered outputs to x₀[n₁,n₂] and x₁[n₁,n₂] be y₀[n₁,n₂] and y₁[n₁,n₂], respectively. If C_{T}(yᵢ[n₁,n₂]) for i=0,1 represents the number of “zipper” pixels in yᵢ[n₁,n₂] which have a magnitude larger than T, then one presented method for field order detection is to use the decision rule in the following equation:

$${C}_{T} ( {y}_{1} [ {n}_{1} , {n}_{2} ] ) \begin{matrix}top first \\ > \\ < \\ bottom first\end{matrix} {C}_{T} ( {y}_{0} [ {n}_{1} , {n}_{2} ] ) \qquad ( 2 )$$

which can be rewritten using R^{T}_{N} as a ratio test:

$${R}_{N}^{T} ≡ ( \frac{{C}_{T} ( {y}_{1} [ {n}_{1} , {n}_{2} ] )}{{C}_{T} ( {y}_{0} [ {n}_{1} , {n}_{2} ] )} ) \begin{matrix}\begin{matrix}\begin{matrix}top first \\ >\end{matrix} \\ <\end{matrix} \\ bottom first\end{matrix} 1 \qquad ( 3 )$$

where in R^{T}_{N}, N refers to the length N zipper filter used to generate yᵢ[n₁,n₂], and T refers to the threshold. Another embodiment that eliminates the threshold T uses the following decision rule, where l=1 or 2, corresponding to an L¹ or L² type norm, respectively:

$${R}_{N}^{l} ≡ ( \frac{{\sum }_{{n}_{2}} {\sum }_{{n}_{1}} {\vert {y}_{1} [ {n}_{1} , {n}_{2} ] \vert}^{l}}{{\sum }_{{n}_{2}} {\sum }_{{n}_{1}} {\vert {y}_{0} [ {n}_{1} , {n}_{2} ] \vert}^{l}} ) \begin{matrix}top first \\ > \\ < \\ bottom first\end{matrix} 1 \qquad ( 4 )$$

where in R^{l}_{N}, N refers to the length N zipper filter used to generate yᵢ[n₁,n₂], and l refers to the norm. The condition in equation (4) simply compares the energy in the filtered outputs y₀[n₁,n₂] and y₁[n₁,n₂], and does not require specification of a threshold T. A block diagram of the method used in calculating equation (4) is shown in FIG. 6. It follows that if X₀(ω₁, ω₂), X₁(ω₁, ω₂), and H_{Z}(ω₁, ω₂) are the discrete-space Fourier transforms of x₀[n₁,n₂], x₁[n₁,n₂], and h_{Z}[n₁,n₂] respectively, then for l=2, the decision rule in equation (4) can be expressed in the frequency domain as:

$${\int }_{0}^{2 π} {\int }_{0}^{2 π} {\vert {H}_{z} ( {ω}_{1} , {ω}_{2} ) \vert}^{2} ( {\vert {X}_{1} ( {ω}_{1} , {ω}_{2} ) \vert}^{2} - {\vert {X}_{0} ( {ω}_{1} , {ω}_{2} ) \vert}^{2} ) d {ω}_{1} , d {ω}_{2} \begin{matrix}top first \\ > \\ < \\ bottom first\end{matrix} 0 \qquad ( 5 )$$

For h_{Z}[n₁,n₂] in equation (1), |H_{Z}(ω₁, ω₂)| for N even (positive, finite) is:

$$\vert {H}_{z} ( {ω}_{1} , {ω}_{2} ) \vert = \vert {\sum }_{k = 0}^{N / 2 - 1} 2 {( - 1 )}^{k} sin ( \frac{( 2 k + 1 ) {ω}_{2}}{2} ) \vert \qquad ( 6 )$$

That is, the zipper filter frequency response is a vertical high-pass filter, with zeros at ω₂=2πi/N (i integer) except at odd multiples of π. Therefore, the decision in equation (5) is based on a vertical frequency weighted energy comparison between X₁(ω₁, ω₂) and X₀(ω₁, ω₂). Note that as N increases (assumed positive and even in this paper), the weighting is more towards (ω₂=π. Although as N gets large the spatial filtering is less localized, an interesting case occurs as N increases well beyond the vertical size of xᵢ[n₁,n₂]. Let Nᵣ and N_{c} be the number of rows and columns, respectively, in xᵢ[n₁,n₂], so that xᵢ[n₁,n₂] is defined to be zero outside 0≦n₁≦N_{c}−1 and 0≦n₂≦Nᵣ−1. In general, N<<Nᵣ. However, when N>>Nᵣ, the magnitude (or magnitude squared) of yᵢ[n₁,n₂] at a given n₁ is constant at:

$${y}_{i}^{l} [ {n}_{1} ] ≡ {\vert {\sum }_{{n}_{2} = 0}^{{N}_{r} - 1} {( - 1 )}^{{n}_{2}} {x}_{i} [ {n}_{1} , {n}_{2} ] \vert}^{l} \qquad ( 7 )$$

Therefore, as N gets very large (boundary effects assumed negligible), the condition in equation (4) can be expressed as:

$${R}_{N -> ∞}^{l} ≡ ( \frac{{\sum }_{{n}_{1} = 0}^{{N}_{c} - 1} {y}_{1}^{l} [ {n}_{1} ]}{{\sum }_{{n}_{1} = 0}^{{N}_{c} - 1} {y}_{o}^{l} [ {n}_{1} ]} ) \begin{matrix}top first \\ > \\ < \\ bottom first\end{matrix} 1 \qquad ( 8 )$$

In equation (7), each row of the two-dimensional signal xᵢ[n₁,n₂] is alternately added or subtracted to obtain a one-dimensional row vector, where the magnitude (or magnitude squared) of the resulting sums are taken. In equation (8), the elements in the one-dimensional row vectors y^{l}₀ and y^{l}₁ are summed, and the ratio is computed. Note that the ratio in equation (8) represents a case where N gets very large, but does not require specification of a particular value of N. The condition in equation (8) can effectively be used for field order detection for the case where N is large. The frequency domain interpretation of this case also yields some interesting insight. Let Xᵢ[k₁,k₂] and H_{Z}[k₁,k₂] represent the N_{c}×N (column×row) discrete Fourier transform of xᵢ[n₁,n₂] and h_{Z}[n₁,n₂-N/2+1], respectively, where h_{Z}[n₁,n₂] defined by equation (1) is now shifted into the first quadrant. It is straightforward to show that |H_{Z}[k₁,k₂]| is:

$$\vert {H}_{z} [ {k}_{1} , {k}_{2} ] \vert = \{ \begin{matrix}N , & {k}_{2} = N / 2 and 0 \leq {k}_{1} \leq {N}_{c} - 1 \\ 0 , & otherwise\end{matrix} \qquad ( 9 )$$

Ignoring aliasing for large N, it follows that (l=2):

$${\sum }_{{n}_{2} = 0}^{N - 1} {\sum }_{{n}_{1} = 0}^{{N}_{c} - 1} {\vert {y}_{i} [ {n}_{1} , {n}_{2} ] \vert}^{2} ≅ \frac{1}{{NN}_{c}} {\sum }_{{k}_{2} = 0}^{N - 1} {\sum }_{{k}_{1} = 0}^{{N}_{c} - 1} {\vert {X}_{i} [ {k}_{1} , {k}_{2} ] {H}_{z} [ {k}_{1} , {k}_{2} ] \vert}^{2} \qquad ( 10 )$$

Substituting equation (9) into equation (10) yields:

$${\sum }_{{n}_{2} = 0}^{N - 1} {\sum }_{{n}_{1} = 0}^{{N}_{c} - 1} {\vert {y}_{i} [ {n}_{1} , {n}_{2} ] \vert}^{2} ≅ \frac{1}{{N}_{c}} {\sum }_{{k}_{1} = 0}^{{N}_{c} - 1} {\vert {X}_{i} [ {k}_{1} , N / 2 ] \vert}^{2} \qquad ( 11 )$$

Using equation (11), the condition in equation (4) with l=2 can be written as:

$$( \frac{{\sum }_{{k}_{1} = 0}^{{N}_{c} - 1} {\vert {X}_{1} [ {k}_{1} , N / 2 ] \vert}^{2}}{{\sum }_{{k}_{1} = 0}^{{N}_{c} - 1} {\vert {X}_{0} [ {k}_{1} , N / 2 ] \vert}^{2}} ) \begin{matrix}top first \\ > \\ < \\ bottom first\end{matrix} 1 \qquad ( 12 )$$

Equation (12) compares the total energy of the two composed frames x₀[n₁,n₂] and x₁[n₁,n₂] in the frequency samples at ω₂=π. It is interesting to note that the first frequency sample (k₁=0) corresponds to:

$$\begin{matrix}{\vert {X}_{i} [ 0 , N / 2 ] \vert}^{2} = \vert {\sum }_{{n}_{2} = 0}^{N - 1} {\sum }_{{n}_{1} = 0}^{{N}_{c} - 1} {( - 1 )}^{{n}_{2}} {x}_{i} [ {n}_{1} , {n}_{2} ] \vert \\ = \vert top field {sum}_{i} - bottom field {sum}_{i} \vert\end{matrix} \qquad ( 13 )$$

where top field sumᵢ and bottom field sumᵢ correspond to the sum of pixels in the top and bottom fields in xᵢ[n₁,n₂], respectively. Although it only represents one frequency sample, the L² measure between the top and bottom fields in equation (13) can be viewed as a simple straightforward measure of interfield motion. This measure, along with the corresponding L¹ measure between the two fields, can be used as a basis for field order detection (l=1 or 2) as follows:

$${R}_{fieldsum}^{l} ≡ ( \frac{{\vert {X}_{1} [ 0 , N / 2 ] \vert}^{l}}{{\vert {X}_{0} [ 0 , N / 2 ] \vert}^{l}} ) \begin{matrix}top first \\ > \\ < \\ bottom first\end{matrix} 1 \qquad ( 14 )$$

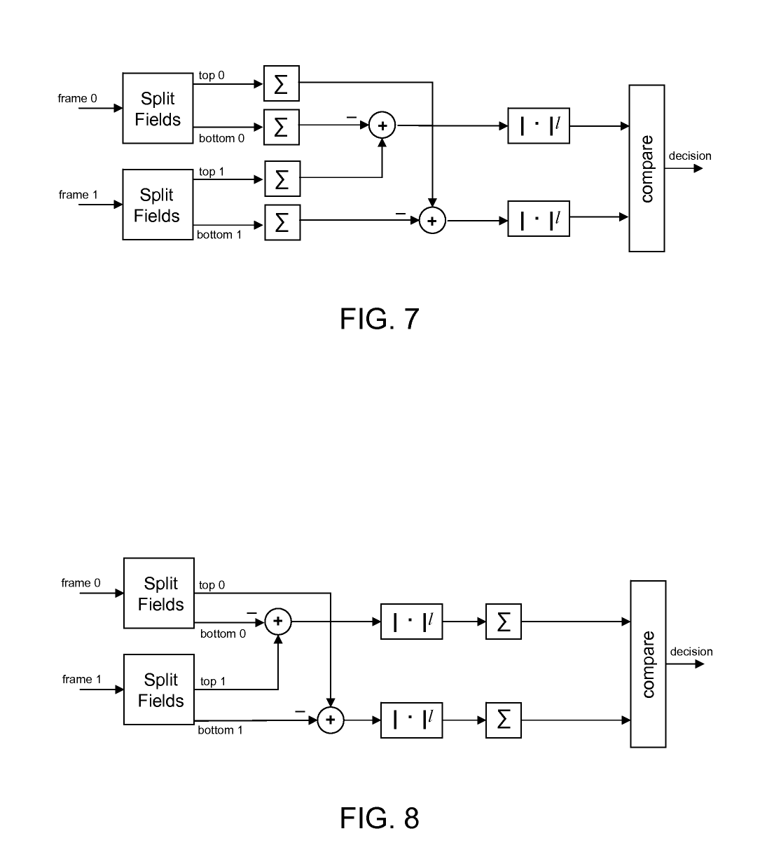

In one embodiment, equation (13) is substituted into equation (14) and the resulting condition simply takes the ratio between the absolute difference of the respective top field DC and bottom field DC, independent of the value N. A block diagram of the method used in calculating equation (14) is shown in FIG. 7. Finally, equation (14) also points to another interfield motion metric condition which compares sums of magnitudes (or magnitudes squared) of the difference between the top and bottom fields as follows (where typically N is even):

$${R}_{field}^{l} ≡ ( \frac{{\sum }_{{n}_{2} = 0}^{{N}_{r} / 2 - 1} {\sum }_{{n}_{1} = 0}^{{N}_{c} - 1} {\vert {x}_{1} [ {n}_{1} , {n}_{2} ] - {x}_{1} [ {n}_{1} , 2 {n}_{2} + 1 ] \vert}^{l}}{{\sum }_{{n}_{2} = 0}^{{N}_{r} / 2 - 1} {\sum }_{{n}_{1} = 0}^{{N}_{c} - 1} {\vert {x}_{0} [ {n}_{1} , 2 {n}_{2} ] - {x}_{0} [ {n}_{1} , 2 {n}_{2} + 1 ] \vert}^{l}} ) \begin{matrix}\begin{matrix}top first \\ >\end{matrix} \\ < \\ bottom first\end{matrix} 1 \qquad ( 15 )$$

In another embodiment, the condition in equation (15) is used for detection, independent of a particular value of N. A block diagram of the method used in calculating equation (15) is shown in FIG. 8.

In general, more than one frame of data is needed for detection, since a single frame contains only one time instance of each field. A field order decision may be made for each current frame based on the current and next frames, and a final decision may also made for the entire sequence based on all the frames. Although there are many possible ways to generate a final sequence decision based on many frame decisions (e.g. field order majority, average decision ratio R, etc.), one method is based on a single decision ratio R value generated from zipper measurements over the entire sequence. In particular, zipper measurements are computed for each successive pair of frames, wherein each frame in the sequence (except the last frame) is treated as the current frame. Afterwards, all the current frame zipper measurements (zipper points, L¹ or L² zipper energy) are then added to obtain the denominator part of the ratio R, whereas all the next frame zipper measurements are added to obtain the numerator part of R. This is illustrated in FIG. 4 where the zipper measurements for the solid lines are combined in the denominator, while those for the dashed lines are combined in the numerator. In this manner, the aggregate ratio R avoids being biased by a single zipper measurement.

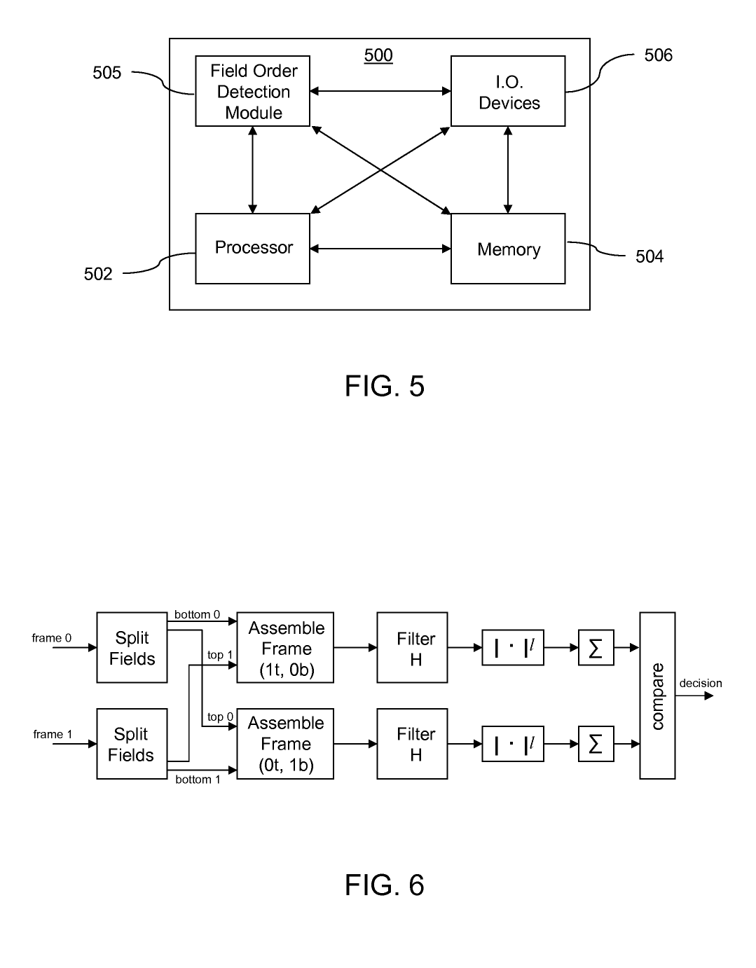

FIG. 5 depicts a high level block diagram of a general purpose computer suitable for use in performing the functions described herein. As depicted in FIG. 5, the system 500 comprises a processor element 502 (e.g., a CPU), a memory 504, e.g., random access memory (RAM) and/or read only memory (ROM) and/or persistent memory (Flash), a field order detection module 505, and various input/output devices 506 (e.g., storage devices, including but not limited to, a tape drive, a floppy drive, a hard disk drive, a compact disk drive, a receiver, a transmitter, a speaker, a display, a speech synthesizer, an output port, and a user input device (such as a keyboard, a keypad, a mouse, etc.) and the like.

It should be noted that the present invention can be implemented in software and/or in a combination of software and hardware, e.g., using application specific integrated circuits (ASIC), a general purpose computer or any other hardware equivalents. In one embodiment, the field order detection module or process 505 can be loaded into memory 504 and executed by processor 502 to implement the functions as discussed above. As such, the present field order detection module 505 (including associated data structures) of the present invention can be stored on a computer readable medium or carrier, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method for determining a temporal sequence of an interlaced image sequence, comprising:
constructing a first field pair and a second field pair from portions of both a first original field pair and a second original field pair from said interlaced image sequence;
filtering said first field pair and said second field pair to produce a respective first output and second output; and
processing said first output and said second output to determine said temporal sequence of said interlaced image sequence.

2. The method of claim 1, wherein said first field pair comprises a top field of said first original field pair and a bottom field of said second original field pair, and said second field pair comprises a bottom field of said first original field pair and a top field of said second original field pair.

3. The method of claim 1, wherein said filtering is performed by applying each of said first field pair and said second field pair to a vertical high pass filter.

4. The method of claim 1, wherein each of said first output and said second output comprises an energy value.

5. The method of claim 3, wherein said vertical high pass filter comprises a zipper filter.

6. The method of claim 5, wherein said zipper filter comprises a six point zipper filter.

7. The method of claim 1, wherein said processing comprises:
comparing said first output to said second output to determine said temporal sequence.

8. The method of claim 7, wherein said interlaced image sequence is classified as top field first if said first output is greater than said second output.

9. A computer readable medium having stored thereon a plurality of instructions, the plurality of instructions including instructions which, when executed by a processor, causes the processor to perform the steps of a method for determining a temporal sequence of an interlaced image sequence, comprising:
constructing a first field pair and a second field pair from portions of both a first original field pair and a second original field pair from said interlaced image sequence;
filtering said first field pair and said second field pair to produce a respective first output and second output; and
processing said first output and said second output to determine said temporal sequence of said interlaced image sequence.

10. The computer readable medium of claim 9, wherein said first field pair comprises a top field of said first original field pair and a bottom field of said second original field pair, and said second field pair comprises a bottom field of said first original field pair and a top field of said second original field pair.

11. The computer readable medium of claim 9, wherein said filtering is performed by applying each of said first field pair and said second field pair to a vertical high pass filter.

12. The computer readable medium of claim 9, wherein each of said first output and said second output comprises an energy value.

13. The computer readable medium of claim 11, wherein said vertical high pass filter comprises a zipper filter.

14. The computer readable medium of claim 13, wherein said zipper filter comprises a six point zipper filter.

15. The computer readable medium of claim 9, wherein said processing comprises:
comparing said first output to said second output to determine said temporal sequence.

16. The computer readable medium of claim 15, wherein said interlaced image sequence is classified as top field first if said first output is greater than said second output.

17. An apparatus for determining a temporal sequence of an interlaced image sequence, comprising:
means for constructing a first field pair and a second field pair from portions of both a first original field pair and a second original field pair from said interlaced image sequence;
means for filtering said first field pair and said second field pair to produce a respective first output and second output; and
means for processing said first output and said second output to determine said temporal sequence of said interlaced image sequence.

18. The apparatus of claim 17, wherein said first field pair comprises a top field of said first original field pair and a bottom field of said second original field pair, and said second field pair comprises a bottom field of said first original field pair and a top field of said second original field pair.

19 The apparatus of claim 17, wherein said means for filtering applies each of said first field pair and said second field pair to a vertical high pass filter.

20. The apparatus of claim 17, wherein each of said first output and said second output comprises an energy value.
